(19) United States
(12) Patent Application Publication
(10) Pub. No.: US 2017/0247893 A1
(43) Pub. Date: Aug. 31, 2017

(54) SHEET FOR PROTECTING A FORMWORK SURFACE, FORMWORK INSTALLATION, METHOD OF PRODUCTION AND METHOD OF USE

(71) Applicant: pro-T-co, Saint-Pal-de-Mons (FR)

(72) Inventors: Jérémy Guichard, La Fouillouse (FR); Michael Ploton, Saint Etienne (FR); André Chalavon, Sainte Sigolène (FR)

(21) Appl. No.: 15/519,560

(22) PCT Filed: Oct. 16, 2015
(86) PCT No.: PCT/EP2015/073959

§ 371 Date: Apr. 17, 2017

(30) Foreign Application Priority Data
Oct. 17, 2014 (FR) 1460018

(51) Int. Cl. E04G 21/30; B32B 27/20; B32B 7/12; B32B 27/08; B32B 3/26; B32B 3/30

(52) U.S. Cl. CPC E04G 21/30; B32B 3/266; B32B 3/30; B32B 7/12; B32B 27/08; B32B 27/20; B32B 2571/00; B32B 2419/00

(57) ABSTRACT

The invention relates to a sheet (10) for protecting a form-work surface, intended to surround a construction material. According to the invention, the sheet (10) comprises at least: a front layer, including at least one polymer material and provided to be in contact with the construction material so as to reduce wear and the formation of grooves on the framework surface and to limit adhesion of the construction material during removal of the formwork; and a rear adhesive layer, provided to be positioned against the formwork surface and rigidly connect the sheet (10) to the formwork surface before the construction material is introduced. The invention also relates to a formwork installation (1) equipped with at least one such sheet (10). The invention further relates to a method of producing and a method of using a sheet (10) of this type.

The present invention relates to a sheet for protecting a formwork surface intended to surround a construction material. The invention also relates to a formwork installation equipped with at least one such sheet. The invention also relates to a method of production and a method of use of such a sheet. The invention relates to the field of formwork equipment.

In a known manner, a formwork installation comprises a temporary enclosure provided to form a construction material, such as concrete, which may or may not be reinforced. According to other non-limiting examples, the material may be cement, plaster or loam.

During the casing operation, the concrete is poured, then maintained in an enclosure while it sets and hardens. The enclosure is defined by form panels provided with casing surfaces, generally made from metal, wood or plywood, which undergo many stresses during use. The shape and surface condition of the formwork surfaces define the final shape and surface condition of the concrete, after hardening and form removal.

During the form removal operation, the formwork surfaces are separated to free the concrete. If the concrete adheres to the formwork surfaces, its surface condition and even its integrity risk being damaged. To facilitate form removal, it is therefore important for the formwork surfaces to have as smooth a surface condition as possible, with no unevenness. Nevertheless, the wear of the formwork surfaces increases over time. Thus, to still further facilitate form removal, it is known to coat the formwork surfaces with oil or a stripping agent before pouring the concrete in the enclosure.

However, the oils or stripping agents commonly used are harmful to workers and pollute the soil around the construction site. Workers must be equipped with specific protective gear, such as a breathing mask, goggles and a protective jumpsuit, which are not always used, despite the corresponding risks and costs. The oil or stripping agent must be applied between each casing operation, which takes time and requires special attention. If this step is done too quickly, oil or stripping agent may flow into the soil, which is both wasteful and a source of pollution for the soil and water tables. Furthermore, some parts of the formwork surfaces may not be covered with oil or stripping agent, and may therefore stick to the concrete. In the case of a reinforced concrete construction, if oil or stripping agent is accidentally applied on the metal frames, the adherence between the concrete and the frames is greatly reduced and the integrity of the construction material may be damaged.

The aim of the present invention is to resolve the aforementioned drawbacks.

To that end, the invention relates to a sheet for protecting a formwork surface, intended to surround a construction material, characterized in that the sheet comprises at least: a front layer, including at least one polymer material and provided to be in contact with the construction material so as to reduce wear and the formation of grooves on the formwork surface and to limit adhesion of the construction material during removal of the formwork; and a rear adhesive layer, provided to be positioned against the formwork surface and to secure the sheet to the formwork surface, before the construction material is introduced.

Thus, the invention makes it possible to facilitate the stripping of the construction material, while avoiding the use of harmful and polluting oils or stripping agents. The final surface condition of the material is improved. The workers no longer need restrictive protective equipment. The soil on the worksite and in the surrounding area is no longer polluted by the oils or stripping agents. The sheet can be applied quickly on the formwork surface. The same sheet can be reused for several successive casing operations, for example five operations in a row, remaining installed on the same formwork surface, which saves time, and therefore considerable amounts of money. Likewise, the same sheet withstands contact with the construction material for several days under worksite conditions (moisture, sunshine, accretion, etc.). Quick cleaning (slight scraping with trowel, abrasive sponge or rag) suffices to clean the sheet between two casing operations, quickly and practically compared to a sequence of cleaning, scraping and oiling the formwork surface. Since the construction material is no longer in direct contact with the formwork surfaces, the invention makes it possible to avoid premature wear of the formwork, improve its lifetime, and therefore save money. The sheet facilitates the flow of any type of concrete. In the case of a reinforced concrete construction, the risk of accidentally applying oil or stripping agent on the metal frames is eliminated. In the case of a metal formwork, it is no longer necessary to wash all of the casing surfaces at a very high pressure and sand them after a worksite, which saves additional time when storing the form panels and still further improve their lifetime. In the case of different form panel sizes, several sheets can be used in order to completely cover the formwork surface.

According to other advantageous features of the invention, considered alone or in combination:
The sheet also comprises a wear indicator layer positioned against the front layer, on the side of the rear adhesive layer.
The wear indicator layer includes at least one polymer material and has a different color from the front layer.
The sheet also comprises: an intermediate layer, including at least one polymer material or another material and positioned against the adhesive layer; and a wear indicator layer inserted between the front layer and the intermediate layer.
The adhesive layer is made up of a double-sided adhesive film or a volume of glue.
The sheet comprises at least one additive integrated into at least one layer including at least one polymer material, for example metal pigments, an anti-UV additive, an elasticator additive, a stiffening additive, a heat resistance additive and/or an antistatic additive.
The sheet includes at least one through hole, predrilled to receive a maintaining key.

The invention also relates to a formwork installation equipped with at least one sheet as described above. The installation can be vertical, in particular to produce a wall, and include two formwork surfaces positioned across from one another. In this case, the installation is preferably equipped with at least two sheets positioned across from one another and defining a formwork volume of the construction material. The installation can be horizontal, in particular to produce a floor or ceiling, and include a single formwork surface positioned below the formwork volume. Depending on the dimensions of the formwork installation, the latter may include several sheets positioned on each formwork surface, defining the formwork volume. In this case, the adjacent sheets can be connected to one another by strips of adhesive tape, or any other suitable means.

The invention also relates to a method for producing a sheet as described above. The method of use is characterized in that it comprises at least the following steps:

a1) producing the front layer, preferably by extrusion;
a2) applying the rear adhesive layer, in particular by lamination or coating, to form the sheet.

Preferably, the front layer is made from plastic. If the sheet comprises several layers of plastic, these layers can be manufactured simultaneously during step a1), in particular by multi-layer extrusion.

In step a2), the adhesive layer can be made up of a double-sided adhesive film (preferably applied by lamination) or a volume of glue (preferably applied by coating).

Generally, step a2) is carried out after step a1). In other words, the rear adhesive layer can be applied on the front plastic layer, or on another intermediate plastic layer, after the at least one plastic layer has been produced.

Alternatively, step a2) is carried out at the same time as step a1). In other words, the rear adhesive layer can be applied on the front plastic layer, or on another intermediate plastic layer, while the at least one plastic layer is being produced. For example, the adhesive layer can be applied online during the extrusion.

The invention also relates to a method for using a sheet as described above. The method of use is characterized in that it comprises at least the following steps:

b1) positioning the rear adhesive layer against the formwork surface, so as to secure the sheet to the formwork surface, before introducing the construction material; and
b2) producing the formwork by bringing the construction material into contact with the front layer.

The invention will be better understood upon reading the following description, provided solely as a non-limiting example and done in reference to the appended drawings, in which:

FIG. 1 is a perspective view of a formwork installation, comprising two form panels provided with formwork surfaces;

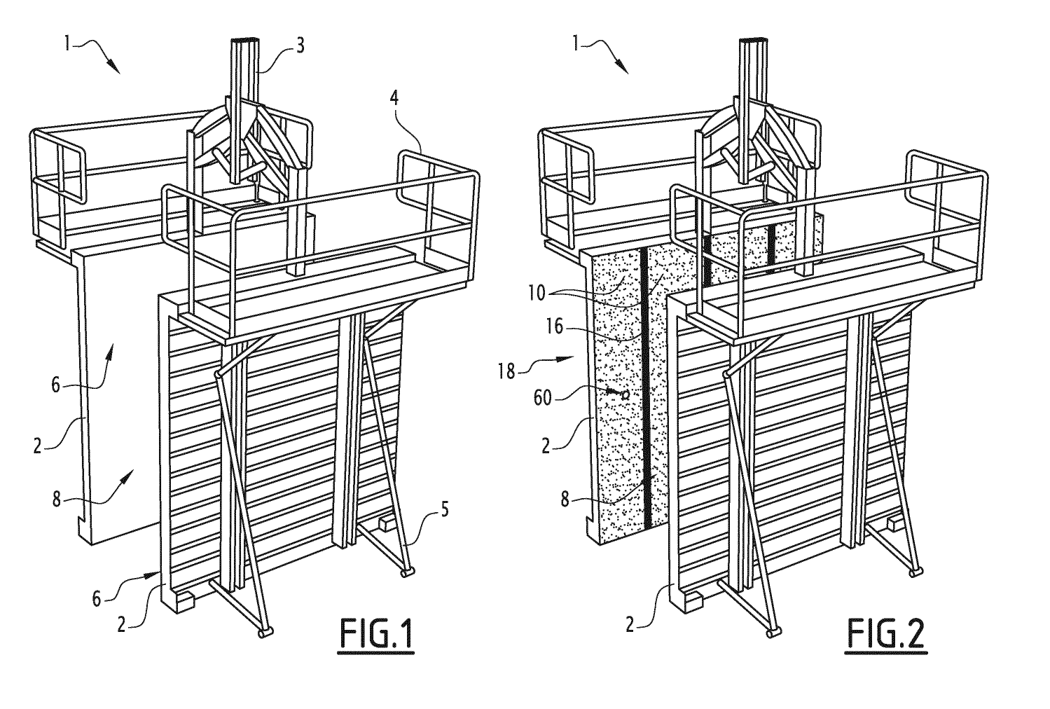

FIG. 2 is a view similar to FIG. 1, the formwork surfaces being equipped with a set of protective sheets according to the invention;

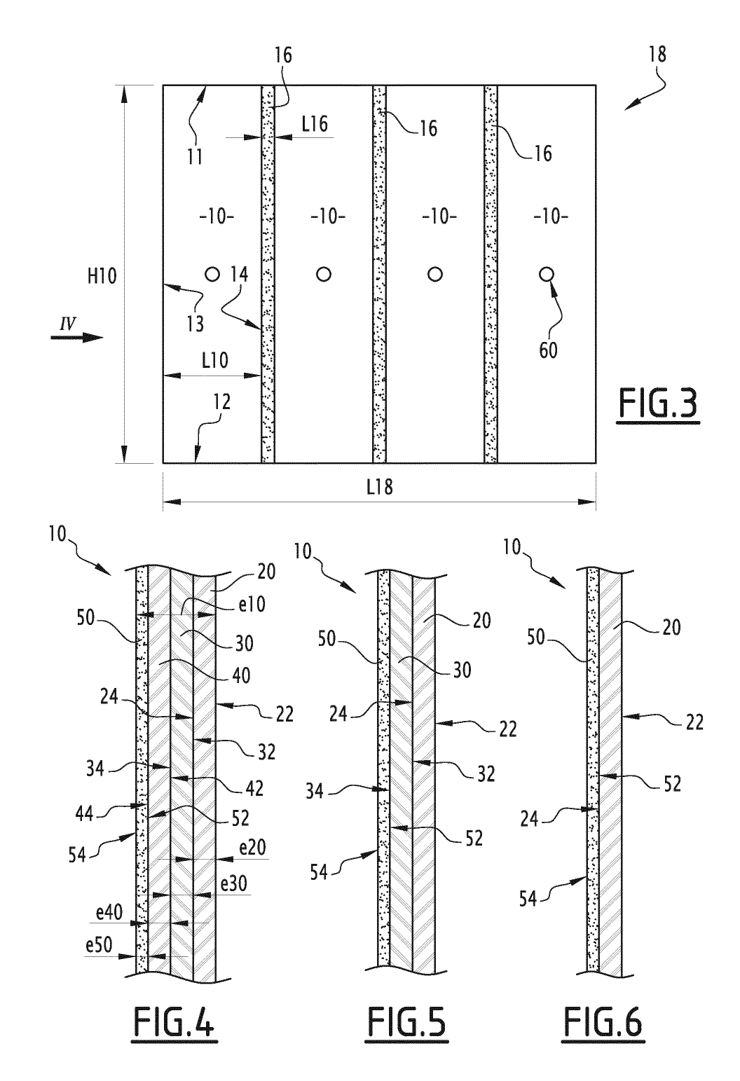

FIG. 3 is a front view of the protective sheets of FIG. 2;

FIG. 4 is a side view of a protective sheet, along arrow IV in FIG. 3;

FIG. 5 is a view similar to FIG. 4, showing a protective sheet according to a second embodiment of the invention; and

FIG. 6 is a view similar to FIG. 4, showing a protective sheet according to a third embodiment of the invention.

FIGS. 1 and 2 show a formwork installation 1. FIG. 1 shows the installation 1 with no protective sheets 10 according to the invention. FIG. 2 shows the installation 1 according to the invention, provided with protective sheets 10.

The installation 1 comprises two form panels 2 positioned across from one another, a handling crane 3, protective barriers 4 and support braces 5. The form panels 2 are also called formwork panels. The form panels 2 are provided with formwork surfaces 6, or casing surfaces 6, positioned across from one another and defining a volume 8 for pouring concrete. The crane or caliper 3 is provided to stabilize the form panels 2 during the casing and to allow them to be lifted opposite one another during stripping. The barriers 4 are positioned in the upper part of the form panels 2, to prevent an operator from falling accidentally. The braces 5 are positioned on the rear of the form panels 2 to stiffen the assembly, in particular when pouring concrete in the volume 8. The installation 1 can include other devices, which are not shown for simplification purposes.

As shown in FIGS. 2 and 3, due to their dimensions, the formwork surfaces 6 are provided with several protective sheets 10 according to the invention. The sheets 10 are positioned side by side, with strips 16 of adhesive tape arranged between them. Together, the sheets 10 and the strips 16 form a protective cover 18 applied on a same surface 6.

The sheet 10 has a globally rectangular shape defined by an upper edge 11, a lower edge 12, a left edge 13 and a right edge 14. The strips 16 are positioned on the surface 6 to partially cover the right edge 14 of the first sheet 10 and the left edge 13 of an adjacent second sheet 10, such that the cover 18 completely covers the surface 6. Indeed, if certain parts of the surface 6 are not covered, two problems may occur. First, concrete may be introduced between the surface 6 and the sheet 10 during pouring. Secondly, concrete could adhere to the surface 6 during stripping. As an example, the strips 16 can be formed by an adhesive jointing film made from acrylic poly propylene. According to one possible, but non-preferred alternative, the sheets 10 can overlap with no strips 16 inserted between them.

The sheet 10 has a height H10 defined vertically between its edges 11 and 12, a width L10 defined horizontally between its edges 13 and 14, and a thickness e10 defined horizontally between a front face 22 and a rear face 54. As non-limiting examples, the height H10 is about 2800 mm (millimeters), the width L10 is about 625 mm and a thickness e10 is about 0.8 mm. Preferably, the thickness e10 of the sheet 10 is greater than 0.2 mm and less than 2 mm. Alternatively, the thickness e10 of the sheet 10 can be less than 0.2 mm or greater than 2 mm. The strips 16 have a width L16, for example about 38 mm. The assembly has a width L18, for example about 4000 mm, corresponding to the width of the formwork surface 3.

The sheet 10 is designed to protect the formwork surface 6 effectively, intended to surround the construction material. The sheet 10 comprises different layers 20, 30, 40 and 50, which have respective thicknesses e20, e30, e40 and e50. The layers 20, 30 and 40 are made with a polymer-based material, optionally including fillers, plasticizers and additives. In other words, the layers 20, 30 and 40 comprise at least one polymer material. Preferably, the layers 20, 30 and 40 are made from plastic. The layer 20 is the front layer or outer layer of the sheet 10. The layers 30 and 40 are the intermediate layers of the sheet 10. The layer 50 is the rear layer or inner layer of the sheet 10, made from an adhesive material. As an example, the thicknesses e20, e30 and e40 are about 0.27 mm, while the thickness e50 is about 0.02 mm.

The layers 20, 30, 40 and 50 have different planar faces connected to one another. The layer 20 has a front face 22 and a rear face 24. The layer 30 has a front face 32 and a rear face 34. The layer 40 has a front face 42 and a rear face 44. The layer 50 has a front face 52 and a rear face 54. The layer 24 is secured to the face 32, the face 34 is secured to the face 42 and the face 44 is secured to the face 52. The close connection between the layers 20, 30 and 40 is produced during their production, while the connection between the layers 40 and 50 is produced when the layer 50 is applied on the layer 40, in particular by lamination or coating.

The layers 20, 30 and 40 can be made from polypropylene, polyethylene, polystyrene, PVC, resin, a composite of different polymers and/or other materials, plant-based plastic or any other materials suitable for the target application. Preferably, the layers 20, 30 and 40 are produced together during a same extrusion operation. Also preferably, the sheet 10 is produced in an individual format, and not in the form of a roll to be cut. The dimensions of the sheet 10 or a series of sheets 10 can easily be adapted to the dimensions of the surface 6 to be protected.

The layer 20 is provided to be positioned in contact with the construction material, opposite the surface 6, during a casing operation. In the example of FIGS. 2 and 3, the front faces 22 of the various sheets 10 and those of the strips 16 border the concrete poured in the volume 8. The layer 20 is designed to have a shock absorbing effect when the concrete is poured, so as to reduce wear and the formation of grooves on the surface 6. The layer 20 is also designed to limit the adhesion of the concrete during stripping.

The layer 30 is a wear indicator layer, produced with a different color from the layers 20 and 40, or at least different from the layer 20. The layer 30 performs a wear indicating function: after several uses of the sheet 10, the front face 32 of the layer 30 appears when the layer 20 is worn or scratched. The wear of the sheet 10 can therefore be detected visually by the workers, after a certain number of uses, for example after four or five successive casing operations. Alternatively, the indicator function of the layer 30 can be performed by any means suitable for the targeted application, other than a color difference.

The layer 40 is designed to facilitate the adhesion of the layer 50 on the face 44, for example by adding a specific additive and/or by texturing the face 44 using one or several textured metal rollers. In this case, the rollers press on the face 44 during the extrusion or after the extrusion. The layers 30 and/or 40 can be designed to stiffen or loosen the sheet 10 slightly, based on the choice of plastic materials and thicknesses e30 and e40.

Furthermore, different additives can be used in the composition of the plastic layers 20, 30 and 40, so as to modify the properties of the sheet 10. For example, the plastic layers (preferably only the layer 40) can incorporate metallic pigments to improve the magnetic power of the magnets, during the placement of shape dummy bars or templates at the formwork installation. According to another example, the plastic layers (preferably only the layer 20 and/or the layer 40) can include a UV (ultraviolet) protection additive, making it possible to improve the resistance of the sheet 10 to UV rays, in particular during storage. According to another example, the plastic layers (preferably only the layer 20) can include an elasticator additive to increase their elasticity, and therefore their shock absorption capacity. According to another example, the plastic layers (preferably only the layer 20) can include a stiffening additive, to control their hardness. According to another example, the plastic layers can include an additive to limit their deformation under the effect of temperature changes, in particular during the casing operation or during storage. According to another example, the plastic layers include an antistatic additive.

The adhesive layer 50 is provided to be positioned against the surface 6, to secure the sheet 10 to the surface 6, before the construction material is introduced into the volume 8 between the form panels 2, during the casing operation. More specifically, the face 54 is provided to adhere to the surface 6. The layer 50 can assume the form of a double-sided adhesive film, or a volume of glue applied on the layer 40 by coating. The layer 50 is designed to remain attached to the layer 40 when the sheet 10 is stripped from the surface 6. In other words, the face 52 remains attached to the face 44 when the face 54 is stripped from the surface 6. Also preferably, the layer 50 extends over the entire sheet 10, in other words over the entire face 44 of the layer 40. Alternatively, the layer 50 extends partially over the sheet 10, in other words over only part of the layer 40. Preferably, the layer 50 is applied on the layer 40 after the extrusion of the layers 20, 30 and 40. Alternatively, the layer 50 can be applied online during the extrusion operation. Advantageously, during the production of the sheet 10, the face 54 of the layer 50 can be covered with a protective film provided with a tab.

In the example of FIGS. 2 and 3, each of the sheets 10 includes a central hole 60, traversing between the faces 22 and 54. The holes 60 are provided for the passage of maintaining keys, i.e., transverse parts positioned in the volume 8 to support the form panels 2. The holes 60 are preferably predrilled during the production of the sheet 10. In an alternative that is not shown, a same sheet 10 can include several holes 60.

The invention also relates to a method for producing a sheet 10. The method comprises a step a1) consisting of producing the layers 20, 30 and 40, preferably by extrusion. The method also comprises a step a2) consisting of applying the layer 50 on the layer 40 to form the sheet 10. Generally, step a2) is carried out after step a1). Alternatively, step a2) is carried out at the same time as step a1). The method may also comprise a step a3), consisting of marking the sheet 10 with a particular pattern, for example shapes, designs, trademarks, logos or any other graphic creation. In particular, the pattern is marked on the layer 20, for example by passing the sheet 10 under a press or roller. Thus, the pattern may be printed on the surface of the concrete during the formwork operation.

The invention also relates to a method for using a sheet 10. The method comprises a step b1), consisting of positioning the layer 50 against the surface 6, so as to secure the sheet 10 and the surface 6, before pouring the concrete. The method next comprises a step b2), consisting of producing the formwork by pouring the concrete in contact with the layer 20. The method also comprises a stripping step b3), carried out after step b2), consisting of stripping the concrete in its final shape. The method may comprise a step b0), carried out before step b1), consisting of predrilling the through hole 60 and/or cutting the edges 11, 12, 13 and 14 of the sheet 10 based on the dimensions of the surface 6. The method may also comprise a step b4), carried out between steps b1) and b2), consisting of positioning jointing strips 16 between the adjacent sheets 10. The method may also comprise other preparatory steps before the casing step b2), as well as other steps after steps b2) and b3).

In the context of the invention, the construction material used for the formwork may be concrete or any other material suitable for the targeted application. The casing operation makes it possible to build walls, floors or any other type of elements, for example concrete barriers, ducts or tiles.

Other embodiments of the invention are described below in reference to FIGS. 5 and 6. In these embodiments, the component elements of the sheet 10 are comparable to those of the first embodiment described above and, for simplification reasons, bear the same numerical references.

In FIG. 5, the sheet 10 comprises a front plastic layer 20, an indicator layer 30 and an adhesive layer 50, but no intermediate plastic layer 40. The adhesive layer 50 is applied on the indicator layer 30.

In FIG. 6, the sheet 10 comprises a front plastic layer 20 and an adhesive layer 50. In this simplified embodiment, the adhesive layer 50 is applied on the plastic layer 20.

Furthermore, the sheet 10 can be configured differently from FIGS. 2 to 6 without going beyond the scope of the invention. In particular, the sheet 10 can have different shapes and sizes based on the targeted application.

In the example of FIGS. 1 and 2, the formwork surfaces 6 are vertical and substantially planar. In an alternative that is not shown, a formwork surface can be horizontal or inclined. According to another alternative, a formwork surface can be concave or convex, and not planar.

According to another alternative that is not shown, the sheet 10 can be thermoformed to give it a particular configuration suitable for the targeted application. A wide variety of shapes of the construction material can thus be obtained after casing.

Irrespective of the embodiment, the sheet 10 comprises at least: a plastic front layer 20, including at least one polymer material and provided to be in contact with the construction material; and a rear adhesive layer 50, provided to be positioned against the formwork surface 6 and to secure the sheet 10 to the formwork surface 6, before the construction material is introduced.

Furthermore, the technical features of the different embodiments and alternatives mentioned above can be combined with one another in whole or in part. Thus, the sheet 10 can be adapted in terms of cost and performance.

1. A sheet for protecting a formwork surface, intended to surround a construction material, wherein the sheet comprises at least:
a front layer, including at least one polymer material and provided to be in contact with the construction material so as to reduce wear and the formation of grooves on the formwork surface and to limit adhesion of the construction material during removal of the formwork; and
a rear adhesive layer, provided to be positioned against the formwork surface and to secure the sheet to the formwork surface, before the construction material is introduced.

2. The sheet according to claim 1, wherein it also comprises a wear indicator layer positioned against the front layer, on the side of the rear adhesive layer.

3. The sheet according to claim 2, wherein the wear indicator layer includes at least one polymer material and has a different color from the front layer .

4. The sheet according to claim 1, wherein it also comprises:
an intermediate layer, including at least one polymer material or another material and positioned against the adhesive layer; and
a wear indicator layer inserted between the front layer and the intermediate layer.

5. The sheet according to claim 1, wherein the adhesive layer is made up of a double-sided adhesive film or a volume of glue.

6. The sheet (10) according to claim 1, wherein it comprises at least one additive integrated into at least one layer including at least one polymer material, for example metal pigments, an anti-UV additive, an elasticator additive, a stiffening additive, a heat resistance additive and/or an antistatic additive.

7. The sheet according to claim 1, wherein it includes at least one through hole, predrilled to receive a maintaining key.

8. A formwork installation, wherein it is equipped with at least one sheet according to claim 1.

9. A method for producing a sheet according to claim 1, wherein it comprises at least the following steps:
a1) producing the front layer, preferably by extrusion;
a2) applying the rear adhesive layer, in particular by lamination or coating, to form the sheet.

10. A method for using a sheet according to claim 1, wherein it comprises at least the following steps:
b1) positioning the rear adhesive layer against the formwork surface, so as to secure the sheet to the formwork surface, before introducing the construction material; and
producing the formwork by bringing the construction material into contact with the front layer.
